(19) United States
(12) Patent Application Publication
(10) Pub. No.: US 2006/0123423 A1
(43) Pub. Date: Jun. 8, 2006

(54) Borrowing threads as a form of load balancing in a multiprocessor data processing system

(75) Inventor: Larry Bert Brenner, Austin, TX (US)

Correspondence Address: DILLON & YUDELL LLP, 8911 N. CAPITAL OF TEXAS HWY.,, SUITE 2110, AUSTIN, TX, 78759, US

(73) Assignee: INTERNATIONAL BUSINESS MACHINES CORPORATION, ARMONK, NY (US)

(21) Appl. No.: 11/006,083

(22) Filed: Dec. 7, 2004

(51) Int. Cl. G06F 9/46

(52) U.S. Cl. 718/105

(57) ABSTRACT

A method and system in a multiprocessor data processing system (MDPS) that enable efficient load balancing between a first processor with idle processor cycles in a first MCM (multi-chip module) and a second busy processor in a second MCM, without significant degradation to the thread's execution efficiency when allocated to the idle processor cycles. A load balancing algorithm is provided that supports both stealing and borrowing of threads across MCMs. An idle processor is allowed to “borrow” a thread from a busy processor in another memory domain (i.e., across MCMs). The thread is borrowed for a single dispatch cycle at a time. When the dispatch cycle is completed, the thread is released back to its parent processor. No change in the memory allocation of the borrowed thread occurs during the dispatch cycle.

### BACKGROUND OF THE INVENTION

1. Technical Field

The present invention relates generally to data processing systems and specifically to multiprocessor data processing systems. Still more particularly, the present invention relates to load balancing among processors of a multiprocessor data processing system.

2. Description of the Related Art

In order to more efficiently complete execution of software code, processors of most conventional data processing systems process code as threads of instructions. With multiprocessor data processing systems (MDPS), threads are utilized to enable definable division of labor amongst various processors when processing code. Multiple threads may be processed by a single processor and each processor may simultaneously process a different thread. Those skilled in the art are familiar with the use of threads and scheduling of threads of instructions for execution on processors.

The processors in MDPS operate in concert with each other to complete the various tasks performed by the data processing system. These tasks are assigned to specific processors or shared among the processors. Because of various factors, it is quite common for the processing loads shared among the processors to be unevenly distributed. In fact, in some instances, one processor in the MDPS may be idle (i.e., not currently processing any threads) while another processor in the MDPS is very busy (i.e., assigned to process several threads).

Current load balancing algorithms in AIX allow an idle (second) processor to “steal” a thread from an adequately busy first processor. When this stealing of a thread is completed, the thread's run queue assignment (i.e., the processor queue to which the thread is assigned for execution) is changed, so that the stolen thread becomes semi-permanently assigned to the stealing processor. The stolen thread will then have a strong tendency to be serviced by this processor in the future. With the conventional algorithm/protocol for stealing threads, the initial dispatch(es) of the thread's instructions on the stealing processor typically encounters extra cache misses, although subsequent re-dispatches eventually become efficient.

Because the thread stealing algorithm causes extra cache misses during the initial dispatch(es), conventional algorithms have introduced a stealing “barrier” that prevents stealing threads from processors that are not overloaded (or not close to being overloaded). This use of a stealing barrier trades off wasted processor cycles against inefficient utilization of processor cycles, which may result from overly aggressive thread stealing, by perhaps leaving an idle processor in an idle state.

The newer POWER™ processor models potentially have an additional penalty when stealing threads. This additional penalty is caused because of the multi-chip-module (MCM)-based architecture utilized in designing the POWER processor models. In POWER processor design, an MCM is a small group of processors (e.g., four processors) that share L3 cache and physical memory. MCMs may be connected to other MCMs in a larger system that provides enhanced processing capabilities.

Because of the shared cache and memory configuration for processors of an MCM stealing threads within an MCM (i.e., stealing from a first processor of a first MCM by a second processor of the same, local MCM) is more desirable than stealing from a processor in second, non-local MCM. With the advent of new memory affinity controls for processes in AIX 5.3, for example, an executing process may have its memory pages backed in storage local to the MCM, making it especially desirable to limit stealing to within the MCM.

Further, it is well known that allowing stealing more freely will seriously impact the stolen thread's memory locality and cause noticeable degradation of performance for the stolen thread. The degradation of performance caused by stealing threads (as well as other negative effects of stealing threads) is even more pronounced when the thread is stolen from another MCM. Thus, while restricting cross-MCM thread stealing may result in more wasted cycles on idle processors, allowing cross-MCM thread stealing leads to measurable degradation to the threads involved. This degradation is in part due to long term remote execution and inconsistent performance for that thread. Stealing threads across MCMs is, therefore, particularly undesirable.

Some developers have suggested an approach called “remote execution.” In some instances, an entire process created at a home node (MCM) is off-loaded to a remote node (MCM) for an extended period of time and may eventually be moved back to the home node (MCM). Often, all of the memory objects of the process are later moved to the new node (which then becomes the home node). While the time frame for moving the memory objects may be delayed with this method, the method introduces the same penalties as up-front stealing of threads across MCMs or running threads for extended periods on a remote MCM while the thread's memory objects are at a different home MCM.

Consequently, the present invention recognizes that a new mechanism is desired that will allow idle processor cycles to be used without permanent degradation to the threads assigned to these idle cycles. A new load balancing algorithm for MCM-to-MCM balancing that prevents long term degradation to the threads involved would be a welcomed improvement. These and other benefits are provided by the invention described herein.

### SUMMARY OF THE INVENTION

A method and system are disclosed that enables efficient load balancing between a first processor with idle processor cycles in a first MCM (multi-chip module) and a second busy processor in a second MCM, without significant degradation to the thread's execution efficiency when allocated to the idle processor cycles. The invention is applicable to a multiprocessor data processing system (MDPS) that includes two or more multi-chip modules (MCMs) and a load balancing algorithm that supports both stealing and borrowing of threads across MCMs.

An idle processor is allowed to “borrow” a thread from a busy processor in another memory domain (i.e., across MCMs). The thread is borrowed for a single dispatch cycle at a time. When the dispatch cycle is completed, the thread is released back to its parent processor. If it is determined that the borrowing processor will become idle after the dispatch cycle, the borrowing processor re-scans the entire MDPS for another thread to borrow.

The next borrowed thread may come from the same lending processor or from another busy processor. Also, the lending processor may loan a different thread to the borrowing processor. Thus, the allocation algorithm does not “assign” a thread to another MCM. Rather the thread is run on the other MCM for a single dispatch cycle at a time, and execution of the thread is immediately returned to the home (lending) processor at the other MCM.

By causing the borrowing processor to release the thread and then rescan the entire MDPS, the algorithm substantially diminishes the likelihood that any single thread will run continuously on a particular borrowing processor. Accordingly, the algorithm also substantially diminishes the likelihood that any performance penalty will accumulate against the borrowed thread caused by loss of memory locality since any new memory objects created by the borrowed thread will be allocated locally with respect to its home MCM.

The above as well as additional objectives, features, and advantages of the present invention will become apparent in the following detailed written description.

### BRIEF DESCRIPTION OF THE DRAWINGS

The invention itself, as well as a preferred mode of use, further objects, and advantages thereof, will best be understood by reference to the following detailed description of an illustrative embodiment when read in conjunction with the accompanying drawings, wherein:

FIG. 1 is a block diagram of a multiprocessor data processing system (MDPS) with two multi-chip modules (MCMs) within which the features of the invention may advantageously be implemented, according to one embodiment of the invention;

FIG. 2 is a flow chart illustrating the process of borrowing threads across two MCMs in accordance with one embodiment of the invention;

FIG. 3 is a flow chart illustrating the process by which a load balancing algorithm determines whether a processor with idle cycles should steal or borrow a thread from a busy processor, according to one embodiment of the invention; and

FIG. 4 is a chart illustrating the borrowing of threads across MCMs per dispatch cycle according to one embodiment of the invention.

### DETAILED DESCRIPTION OF AN ILLUSTRATIVE EMBODIMENT

The present invention provides a method and system that enables efficient load balancing between a first processor with idle processor cycles in a first MCM (multi-chip module) and a second busy processor in a second MCM, without significant (long term) degradation to the thread's execution efficiency when allocated to the idle processor cycles. The invention is applicable to a multiprocessor data processing system (MDPS) that includes two or more multi-chip modules (MCMs) and a load balancing algorithm that supports both stealing and borrowing of threads across MCMs.

As utilized herein, the term “idle” refers to a processor that is not presently processing any threads or does not have any threads assigned to its thread queue. “Busy” in contrast refers to a processor with several threads scheduled for execution within the processor's thread queue. This parameter may be defined within the load balancing algorithm as a specific number of threads (e.g., 4 threads) within the processor's thread queue. Alternatively, the busy parameter may be defined based on a calculated average across the MDPS during processing, where a processor that is significantly above the average is labeled as busy, relative to the other processors. The load balancing algorithm maintains (or attempts to maintain) a smoothed average load value, determined by repeatedly sampling the queue lengths of each processor.

An idle processor is allowed to “borrow” a thread from a busy processor in another memory domain (i.e., across MCMs). The thread is borrowed for a single dispatch cycle at a time. When the dispatch cycle is completed, the thread is released back to its parent processor. If it is determined that the borrowing processor will become idle after the dispatch cycle, the borrowing processor re-scans the entire MDPS for another thread to borrow.

The next borrowed thread may come from the same lending processor or from another busy processor. Also, the lending processor may loan a different thread to the borrowing processor. Thus, the allocation algorithm does not “assign” a thread to another MCM. Rather the thread is run on the other MCM for a single dispatch cycle at a time, and execution of the thread is immediately returned to the home (lending) processor at the other MCM.

By causing the borrowing processor to release the thread and then rescan the entire MDPS, the algorithm substantially diminishes the likelihood that any single thread will run continuously on a particular borrowing processor. Finally, all references made to memory objects by the borrowed thread are resolved with memory local to the lending MCM, not to the MCM actually executing the borrowed thread. The borrowed thread remains optimized for future execution on its “home” MCM. Accordingly, the algorithm also substantially diminishes the likelihood that any performance penalty will accumulate against the borrowed thread caused by loss of memory locality since the process does not require cross-MCM migration of memory objects when it runs on its home MCM.

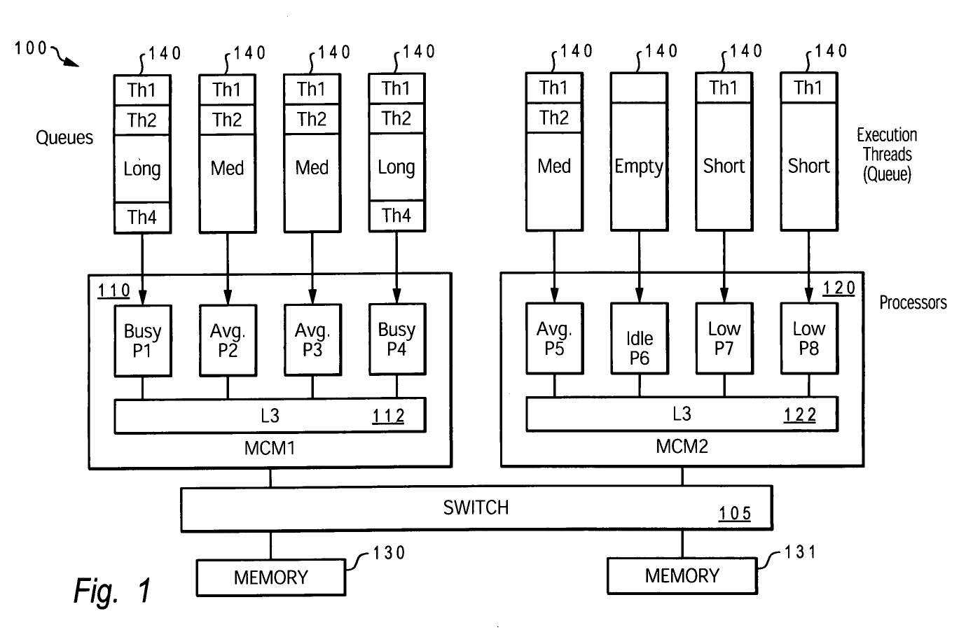

With reference now to the figures and in particular to FIG. 1, there is illustrated an exemplary multiprocessor data processing system (MDPS) with two four-processor multi-chip modules (MCMs) within which the features of the invention are described. MDPS 100 comprises two MCMs, MCM1 110 and MCM2 120. Each MCM comprises four processors, namely P1-P4 for MCM1 110 and P5-P8 for MCM2 120. Processors P1-P4 shared common L3 cache 112 and memory 130, while and processors P5-P8 share common L3 cache 122 and memory 131. Memory 130 is local to MCM1 110, while memory 131 is local to MCM2 120. Each memory 130, 131 has remote access penalties for non-local MCMs, MCM2 120 and MCM1 110, respectively.

MCM1 110 is connected to MCM2 120 via a switch 105. Switch 105 is a collection of connection wires that, in one embodiment, enables each processor of MCM1 110 to directly connect to each processor of MCM2 120. Switch 105 also connects memory 130, 131 to its respective local MCM (as well as to the non-local MCM).

During operation of MDPS 100, each processor (or central processing unit (CPU) is assigned an execution queue (or thread queue) 140 within which threads (labeled Th1 . . . THn) are scheduled for execution by the particular processor. At any given time during processing, the number of threads (i.e., load) being handled (sequentially executed) by any one of the processors may be different from the number of threads (load) being handled by another processor. Also, the overall load of one MCM (e.g., MCM1 110) may be very different from that of the other MCM (MCM2 120). An indication of the relative load of each processor is provided in FIG. 1 as “business” labels (busy, average, low, and idle) within the specific processor, and the number of threads in the corresponding queues is indicated with “length” labels (long, medium, short, and empty). The load parameter is assumed to be directly correlated to the number of threads scheduled to execute (i.e., the length of the queue) at the particular processor.

Thus, as illustrated, processors P1 and P4 of MCM1 110 have long queues with four (or more) threads scheduled, and P1 and P4 are labeled as “busy”. Processors P2 and P3, also of MCM1 110 and processor P5 of MCM2 120 have medium length queues (with two threads scheduled), and P2, P3, and P5 are labeled as “average”. Processors P7 and P8 of MCM2 120 are labeled as “low” since they have short queues with only one thread scheduled, respectively. Finally, processor P6 of MCM2 120 has an empty queue (i.e., no threads scheduled), and P6 is labeled as idle.

The specific thread counts provided herein are for illustration only and not meant to imply any limitations on the invention. Specifically, while an idle processor is described as having no threads assigned thereto, it is understood that the threshold for determining which processor has idle cycles and is a candidate for borrowing (or stealing) threads is set by the load balancing algorithm implemented within the particular MDPS. This threshold may be a processor with two or three or ten threads scheduled depending to some extent on the depth of the thread queues and operating parameters of the processor(s). However, the illustrative embodiment assumes that a borrowing/stealing processor borrows (or steals) a thread only when the borrowing/stealing processor's “run queue” is empty. The load average is then used at such instants to decide whether to allow the processor to borrow (or a steal) a thread from another processor.

Notably, the overall load of (i.e., number of threads executing on) MCM2 120 is significantly lower than that of MCM1 110. This imbalance is utilized to describe the load balancing process of the invention to relieve the load imbalances, specifically to relieve busy processor P1, without causing any significant long-term deterioration in the threads execution efficiency. The description of the present invention is thus presented to address a load imbalance across MCMs by implementing a borrowing algorithm, where appropriate, based on a load balancing analysis that takes into account the load relief available via a stealing algorithm.

Accordingly, a significant load average difference between two MCMs is used to determine when stealing is allowed. Lacking such a significant imbalance, borrowing will be allowed if the borrowing node has significant idle time (i.e., relatively small load average per processor) and the lending node does not have significant idle time. If a node has significant idle time, stealing of threads are done locally and no borrowing across-MCM is performed.

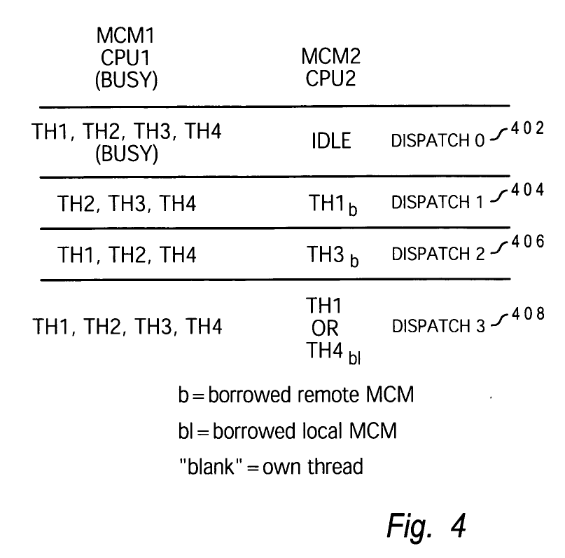

Features of the invention may generally be described with reference to FIG. 4, which shows the borrowing of threads at each dispatch cycle from a processor of the first MCM by a processor of the second MCM. More specifically, idle processor P6 of MCM2 120 is shown borrowing threads from busy processor P1 of MCM1 110. The use of specific processors within the description, which follows, is solely to facilitate describing the process and not meant to be limiting on the invention. Further, it should be noted that FIG. 4 initially assumes that there is an idle processor in the MCM2 and no idle processors within MCM1. The initial thread borrowing illustrated in FIG. 4 thus occurs across MCMs, rather than within a local MCM.

In FIG. 4, a borrowed thread is identified with a subscript “b” and a stolen thread from another processor in the same (local) MCM is identified with subscript “s.” No subscript (“blank”) is provided when the thread is executing on its home processor. During the first dispatch cycle 402, P6 is idle, while P1 is extremely busy (having to schedule four threads). In the second dispatch cycle 404, P6 has borrowed a thread (Th1) from P1, and P6 executes the thread (Th1) for that dispatch cycle. Once the second dispatch cycle is completed, P2 releases the thread (Th1) back to P1.

Then, in the third dispatch cycle 406 P1 again borrows a thread from P1. However, the thread (Th3) borrowed this time is different from the original thread (Th1) borrowed. Again, P6 releases the thread (Th3) back to P1 when the dispatch cycle ends. During dispatch cycle 4 408 P6 receives its own thread to execute or receives a thread from the local MCM. P1 continues to execute its four threads, while P6 begins executing threads local to itself or to its MCM.

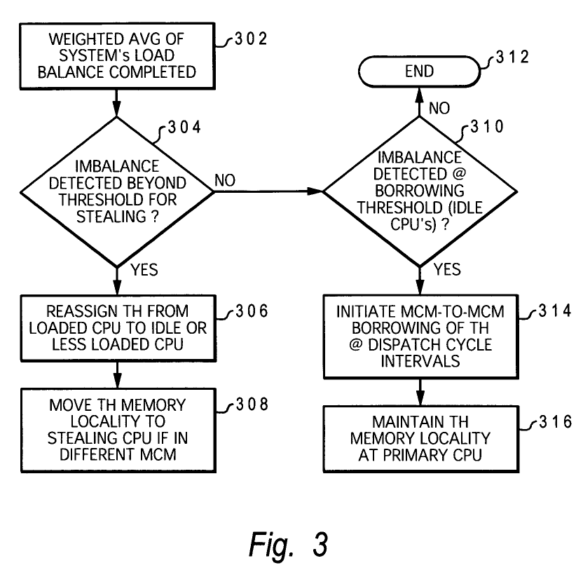

FIG. 3 is a flow chart which illustrates the paths taken for two different ways of handling of a load imbalance in the MDPS using a load balancing algorithm that enables both stealing and borrowing of threads, where appropriate. The processors are referred to as busy processor, stealing processor, idle processor, and borrowing processor to indicate the respective processor's load balancing state. The process begins at block 302 at which the weighted average of the MDPS' load is computed. A determination is then made at block 304 whether the imbalance detected surpasses a threshold minimum imbalance allowed for authorizing stealing (versus merely borrowing) of threads. When the threshold minimum has been surpassed, an entire thread is reassigned from a busy processor to the other previously-idle (less busy) processor at block 306. The memory locality of the thread is also changed to a memory affiliated with the stealing processor at block 308. Notably, stealing between/across MCMs requires a substantial load imbalance with the two MCMs, while stealing within an MCM does not have such a stringent requirement.

Returning to decision block 304, when the imbalance is not beyond the threshold required to initiate the stealing process, a next determination is made at block 310 whether the imbalance detected is at the cross-MCM borrowing threshold. When the threshold for borrowing is not surpassed, the load balancing process is ended at block 312. When the threshold is surpassed, however, the cross-MCM borrowing algorithm is activated and MCM-to-MCM borrowing of threads commences at dispatch cycle intervals, as shown at block 314. Unlike with the thread stealing algorithm, the memory locality, etc. of the borrowed thread are maintained at the MCM of the lending processor, as illustrated at block 316.

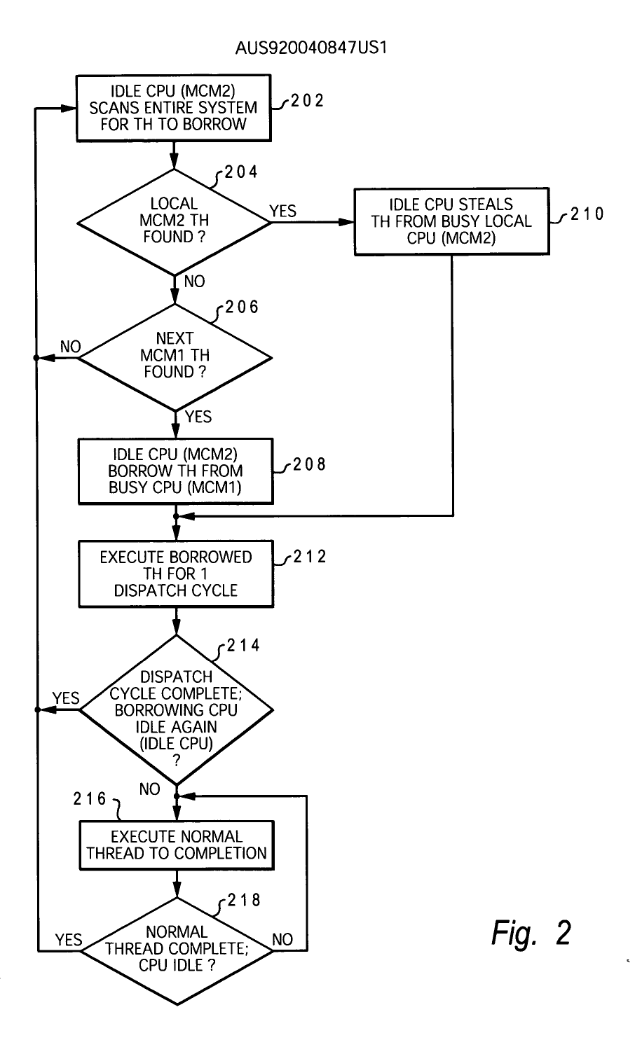

FIG. 2 provides a flow chart of the process of providing cross-MCM load balancing within MDPS 100 of FIG. 1. Assumptions made by this process include: (1) Any busy processors requiring relief in MCM2 120 forces stealing of threads from the local MCM (i.e., stealing threads is addressed with reference to FIG. 3, described above); (2) there is a busy processor in MCM1 110 and a processor with idle cycles in MCM2 120; and (3) the borrowing processor is initially idle. The order presented by the flow chart is not meant to imply any limitations on the invention, and it is understood that the different blocks may be rearranged relative to each other in the process.

The process of FIG. 2 begins at block 202 which illustrates a load balancing (or borrowing) algorithm initiating a scan of MDPS 100 for a thread to borrow for idle processor P6 (referred to interchangeably as idle processor or borrowing processor or processor P6 to identify the processor's current state) of MCM2 120. Prior to searching for threads to borrow or steal, the processor P6 must first determine if there is work (a scheduled thread) on its own run queue and completing the execution of the scheduled thread, if present. Only when there is no thread scheduled within its own queue can processor P6 initiate a scan to steal or borrow threads from another processor.

Returning to FIG. 2, a determination is then made at block 204 whether there are available threads within the local MCM2 120. If there are threads local to MCM2 120 of idle processor P6, then idle processor P6 is made to steal a thread from one of the busier local processors of MCM2 120, as indicated at block 210.

When there are no busy local processors from which idle processor P6 can steal a thread, a next determination is made at block 206 whether there is a busy processor with available threads within MCM1 110. The algorithm causes the idle processor P6 to continue scanning the MDPS until the idle processor P6 finds a thread to borrow or steal, or until the idle processor P6 is assigned a thread and is no longer idle.

When there is a thread available from a processor of MCM1 110, the idle processor P6 receives the borrowed thread, and P6 executes the borrowed thread at block 212 during the dispatch cycle. Borrowing processor P6 arranges for all future data references of the borrowed thread that allocate memory do so locally to the lending processor during the dispatch cycle, in one embodiment, but does not move/change any of the previous allocation within the remote memory of MCM1 110. Borrowing processor P6 thus treats the borrowed thread as if it were actually being run by the lending processor.

A check is made at block 214, just prior to completion of the dispatch cycle, whether the borrowing processor will become idle again (i.e., have idle processing cycles available for allocation to a thread). If processor P6 will become idle, the borrowing algorithm again conducts a scan of the MDPS for an available thread to borrow or steal. Notably, the idle processor P6 may steal, borrow, or ignore a thread waiting in another processor's run queue, depending on determined load values. However, the present invention addresses only the borrowing of threads.

The processor P6 will not become idle following the dispatch cycle if a normal thread is assigned to processor. The processor-assigned/scheduled thread (i.e., the local thread (which a stolen thread implicitly becomes) stays assigned to be run on the same processor, so that after each of its dispatch cycles, the thread will next be expected to run on its local processor (unless the processor becomes too busy and is forced to lend the thread to another idle processor, for example) as shown at block 216. When the normal thread is complete, the processor again goes into idle state, which is determined at block 218. Once processor P6 becomes idle, borrowing/stealing algorithm is triggered to automatically search for busy processors from which to borrow/steal threads for processor P6.

In one embodiment, encountering a page fault is treated as a terminating condition for the borrowed dispatch cycle if paging input/output (I/O) is required. An assumption is made that the thread is probably going to resume executing on the owning/lending processor after the page fault is resolved. Thus, wherever the thread next runs, the page will be made resident in memory local to the thread's home MCM (unless the thread is stolen by a processor in another MCM). (0046] As described in more detail below, there are two borrowing load average requirements: (1) the borrowing processor and its MCM overall must have “sufficient” anticipated spare time (cycles) to give away, and the lending processor and its MCM must not have “sufficient” anticipated spare time (cycles) to get to the thread soon.

Several additional important details of the implementation include:
(1) While the new memory affinity management code in AIX will normally allocate pages from memory local to the MCM containing the processor executing the thread (i.e., the borrowing processor), the thread borrowing algorithm forces allocation to the “owning” (lending) processor's MCM instead. In this way, because the thread is not meant to run long-term on the borrowing processor, the supporting parameters are set up to optimize the thread's memory locality at which the thread is most likely to run in the future;
(2) New “barriers” to prevent undesirable borrowing are included in the load balancing protocol. Accordingly, an idle processor in an otherwise busy MCM will not lend cycles to another MCM, but will wait and give the idle cycles to a processor in its own local MCM. Also, an idle processor in one MCM will not lend processing cycles to a busy processor of another lightly loaded MCM. Accordingly, in one embodiment, the thread borrowing algorithm is instructive only, since the load balancing algorithm generally assumes it is best to let a soon to be idle processor within the local MCM perform a normal thread steal rather than permit cross-MCM thread borrowing. The exact values for how busy the two involved MCMs must be to permit borrowing by one from another is a design parameter, as described above, which maximizes use of idle processor cycles while minimizes inefficiencies which may be caused by borrowing and stealing threads across-MCMs; and
(3) Stealing, which has a higher barrier against it than borrowing, is given precedence over borrowing. Whenever the option to complete both stealing and borrowing are feasible options, stealing is performed. That is, stealing is necessary to overcome a significant long-term load imbalance, and a significant amount of borrowing is not utilized to hide this imbalance. In particular, the stealing barrier is a function of the load averages of the involved MCMs. Further analysis is implemented during thread allocation to prevent the borrowing process from distorting these load averages.

Thus, the load average of a processor is determined by sampling the length of the queue of threads awaiting execution on that processor. With borrowing being an available option, the sample becomes: queue length+threads_sent_to other_PROCESSORs-B, where B is 1 only when the PROCESSOR is running a borrowed thread, and otherwise B is 0.

Benefits of the invention include the implementation of a new load balancing algorithm for MCM-to-MCM balancing that prevents long term degradation to the threads involved. In other words, the cross-MCM borrowing algorithm leads to a reducing of the penalty for any one thread. All threads are subject to share in temporary re-allocation during the load balancing, and system performance thus remains consistent. Also, in some instances borrowing assists a processor in substantially reducing the processor's backlog.

As a final matter, it is important that while an illustrative embodiment of the present invention has been, and will continue to be, described in the context of a fully functional data processing system with installed management software, those skilled in the art will appreciate that the software aspects of an illustrative embodiment of the present invention are capable of being distributed as a program product in a variety of forms, and that an illustrative embodiment of the present invention applies equally regardless of the particular type of signal bearing media used to actually carry out the distribution. Examples of signal bearing media include recordable type media such as floppy disks, hard disk drives, CD ROMs, and transmission type media such as digital and analogue communication links.

While the invention has been particularly shown and described with reference to an illustrative embodiment, it will be understood by those skilled in the art that various changes in form and detail may be made therein without departing from the spirit and scope of the invention. For example, while the invention is specifically described with the load balancing algorithm using the thread counts to calculate and maintain the load averages, one implementation may track the relative business of the processors (using some other mechanism other than number of threads in the respective queues) and utilize the busy parameters within the load balancing algorithm. Also, while described as an MCM-to-MCM operation, the invention is not limited to such architectures and may be implemented by a mechanism responsible for Non-Uniform Memory Access (NUMA) architectures.

What is claimed is:

1. A multiprocessor data processing system (MDPS) comprising:
a first multi-chip module (MCM) having a first processor with a first processor queue that contains multiple threads;
a second MCM having a second processor with a second processor queue that is empty;
a mechanism for connecting the first MCM to the second MCM; and
load balancing logic that evaluates a load balance among said first MCM and said second MCM an which enables the second processor of the second MCM to borrow and execute a thread from the first processor queue of the first MCM for a dispatch cycle.

2. The MDPS of claim 1, wherein said load balancing logic returns the thread to the first processor queue at the end of the dispatch cycle.

3. The MDPS of claim 1, further comprising:
a first memory component associated with the first MCM and which stores memory data associated with the thread executing at the first MCM;
a second memory component associated with the second MCM and which stores memory data associated with threads executing at the second MCM; and
wherein said load balancing logic further prevents memory objects of the borrowed thread from being moved from the first memory to the second memory during said dispatch cycle.

4. The MDPS of claim 1, wherein said load balancing logic comprises:
a thread stealing algorithm that enables the second processor to steal a thread from the queue of the first processor or the queue of a third processor local to the second MCM; and
a thread borrowing algorithm that initiates a borrowing of the thread for a dispatch cycle when the thread stealing algorithm determines that a current load imbalance is below a threshold required for initiating a stealing of the thread.

5. The MDPS of claim 4, wherein the thread borrowing algorithm forces allocation of memory objects to the memory of the first processor's MCM.

6. The MDPS of claim 1, wherein said load balancing logic comprises software algorithms.

7. In a multiprocessor data processing system (MDPS) with a first multi-chip module (MCM) connected to a second MCM, a method comprising:
analyzing a number of threads assigned to each of multiple processor queues within the first MCM and the second MCM;
determining when at least a first processor of the first MCM is idle while a second processor of the second MCM is busy; and
performing a load balancing of the MDPS by borrowing a thread from a processor queue associated with the second processor and assigning the thread to be executed by the first processor during a next dispatch cycle.

8. The method of claim 7, wherein said determining further comprises tagging the first processor as idle when there are no threads available for execution within a processor queue associated with the first processor and tagging the second processor as busy when there are multiple threads within the second processor's queue.

9. The method of claim 8, further comprising enabling the borrowing of the thread only when the thread being borrowed is not anticipated to be executed by the second processor within the next dispatch cycle.

10. The method of claim 7, further comprising:
determining when a thread of the second processor should be completely reassigned to another processor;
enabling stealing of the thread by another processor responsive to the determining that the thread should be completely reassigned; and
allowing said borrowing only when said thread is not to be completely reassigned.

11. The method of claim 10, wherein said allowing comprises determining that a current load imbalance is below a threshold required for initiating a stealing of the thread.

12. The method of claim 7, further comprising returning the thread to the second processor queue at the end of the next dispatch cycle.

13. The method of claim 7, further comprising:
retaining memory objects of the borrowed thread within a second memory associated with the second MCM during said next dispatch cycle; and
allocating memory objects during said dispatch cycle to the second memory of the second MCM.

14. A computer program product comprising:
a computer readable medium; and
program code on said computer readable medium for:
analyzing a number of threads assigned to each of multiple processor queues within a first MCM and a second MCM of a multiprocessor data processing system (MDPS);
determining when at least a first processor of the first MCM is idle while a second processor of the second MCM is busy; and
performing a load balancing of the MDPS by borrowing a thread from a processor queue associated with the second processor and assigning the thread to be executed by the first processor during a next dispatch cycle.

15. The computer program product of claim 14, wherein said program code for determining further comprises code for tagging the first processor as idle when there are no threads available for execution within a processor queue associated with the first processor and tagging the second processor as busy when there are multiple threads within the second processor's queue.

16. The computer program product of claim 15, further comprising program code for enabling the borrowing of the thread only when the thread being borrowed is not anticipated to be executed by the second processor within the next dispatch cycle.

17. The computer program product of claim 14, further comprising program code for:
determining when a thread of the second processor should be completely reassigned to another processor;
enabling stealing of the thread by another processor responsive to the determining that the thread should be completely reassigned; and
allowing said borrowing only when said thread is not to be completely reassigned.

18. The computer program product of claim 10, wherein said program code for allowing comprises code for determining that a current load imbalance is below a threshold required for initiating a stealing of the thread.

19. The computer program product of claim 14, further comprising program code for returning the thread to the second processor queue at the end of the next dispatch cycle.

20. The computer program product of claim 14, further comprising program code for:
retaining memory objects of the borrowed thread within a second memory associated with the second MCM during said next dispatch cycle; and
allocating memory objects during said dispatch cycle to the second memory of the second MCM.
